(19) United States
(12) Patent Application Publication
(10) Pub. No.: US 2026/0301008 A1
(43) Pub. Date: Oct. 1, 2026

(54) PREDICTIVE MODEL WITH MULTI-MODAL INPUT

(71) Applicant: Neptune Retail Solutions, Jersey City, NJ (US)

(72) Inventors: Lori Bush, Summit, NJ (US); David Fanska, Loveland, OH (US)

(21) Appl. No.: 19/096,155

(22) Filed: Mar. 31, 2025

(51) Int. Cl. G06Q 30/0202; G06Q 10/04

(52) U.S. Cl. CPC G06Q 30/0202; G06Q 10/04

(57) ABSTRACT

The present disclosure involves methods, apparatus, and systems for predicting experiment results in a multi-variable environment. This can include: identifying an experiment to perform in a multi-variable environment, wherein the experiment comprises altering one or more variables in the multi-variable environment; providing the experiment to a predictive model to get an estimate of the experiment's effect on one or more non-altered variables of the multi-variable environment; receiving an indication that the experiment is being performed and in response measuring a performance of the experiment as a measured performance; and receiving an indication that the experiment is complete and in response evaluating the accuracy of the predictive model.

### TECHNICAL FIELD

The present disclosure generally relates to predicting experiment results in a multi-variable environment.

### BACKGROUND

Many multi-variable, complex environment can have non-intuitive responses to changing parameters. For example, economic markets can be influenced by a range of factors including season, price, promotions, weather, external events (e.g., sporting game results), or other factors. In order to efficiently select controllable parameters within the multi-variable environment, the changes or effects those controllable parameters have on the environment should be predicted.

### SUMMARY

The present disclosure relates to a method, system, and computer-readable storage media for predicting experiment results in a multi-variable environment. This can include: identifying an experiment to perform in a multi-variable environment, wherein the experiment comprises altering one or more variables in the multi-variable environment; providing the experiment to a predictive model to get an estimate of the experiment's effect on one or more non-altered variables of the multi-variable environment; receiving an indication that the experiment is being performed and in response measuring a performance of the experiment as a measured performance; and receiving an indication that the experiment is complete and in response evaluating the accuracy of the predictive model.

Implementations can optionally include one or more of the following features.

In some instances, the multi-variable environment is an economic market, and wherein altering the one or more variable comprises altering at least one of: price, product, advertising, or availability, and wherein the one or more non-altered variables comprise at least one of sales quantity, revenue amount, customer engagement, or incremental lift.

In some instances, the predictive model is a machine learning model trained using a gradient boosting algorithm.

In some instances, the predictive model is a distributed random forest.

In some instances, the experiment performance is measured based on a change in the one or more non-altered variables compared to a target change.

In some instances, evaluating the accuracy of the predictive model comprises comparing the estimate of the experiment's effect on the one or more non-altered variables to the measured performance.

In some instances, in response to evaluating that the accuracy of the predictive model is below a predetermined threshold, re-training the predictive model on a data set that includes the experiment.

In some instances, this further includes during the experiment, providing initial performance data to the predictive model to generate a predicted performance; and modifying the experiment to enhance the predicted performance.

According to a second aspect, one or more computer-readable storage media is provided. The one or more computer-readable storage media stores one or more instructions that, when executable by one or more computers, cause the one or more computers to perform the method according to the first aspect or one or more implementations of the first aspect.

According to a third aspect, a computer-implemented system is provided. The computer-implemented system includes one or more computers and one or more computer memory devices interoperably coupled with the one or more computers. The one or more computer memory devices have computer-readable storage media storing one or more instructions that, when executed by the one or more computers, perform the method according to the first aspect or one or more implementations of the first aspect.

While generally described as computer-implemented software embodied on tangible media that processes and transforms the respective data, some or all of the aspects can be computer-implemented methods or further included in respective systems or other devices for performing this described functionality. The details of these and other aspects and implementations of the present disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 illustrates a block diagram of an example system for predicting experiment results in a multi-variable environment.

FIG. 2 is a flowchart illustrating an example process for predicting and evaluating experiment results in a multi-variable environment.

FIG. 3 is a flowchart illustrating an example process for measuring experiment performance in a multi-variable environment.

FIG. 4 is a flowchart illustrating an example process for evaluating the accuracy of a predictive model in a multi-variable environment.

FIG. 5 illustrates a schematic diagram of an example computing system.

Like reference numbers and designations in the various drawings indicate like elements.

### DETAILED DESCRIPTION

This specification relates to methods, apparatuses, and systems for predicting experiment results in a multi-variable environment. Multi-variable environments can often include complex interrelations between the different parameters in the environment. This can make it difficult to optimize systems within the environment, or even to determine what will happen when one or more parameters are changed. The proposed solution discusses techniques for measuring, analyzing and predicting the results of changes within the multi-variable environment while leveraging artificial intelligence (AI) and machine learning (ML) techniques. For example, in a hydroponic gardening system, this tool can infer relationships between parameters such as solar irradiance, humidity, temperature, and soil pH, and enable operators to predict harvest or yield in response to changes in those parameters. In another example, in a marketing promotions context, the disclosed tool can predict and measure the performance of various offers, such as digital incentives, discounts, or rebates. This enables sellers to make data-driven planning, budgeting, and optimization decisions.

The disclosed techniques are advantageous in that they leverage machine learning and data analysis techniques to provide insights within complex systems that would otherwise be difficult or impossible predictably interact with. Further, as large amounts of new data is collected, the disclosed tool can update and improve it's predictions, ingesting large quantities of information and providing a holistic perspective on the system.

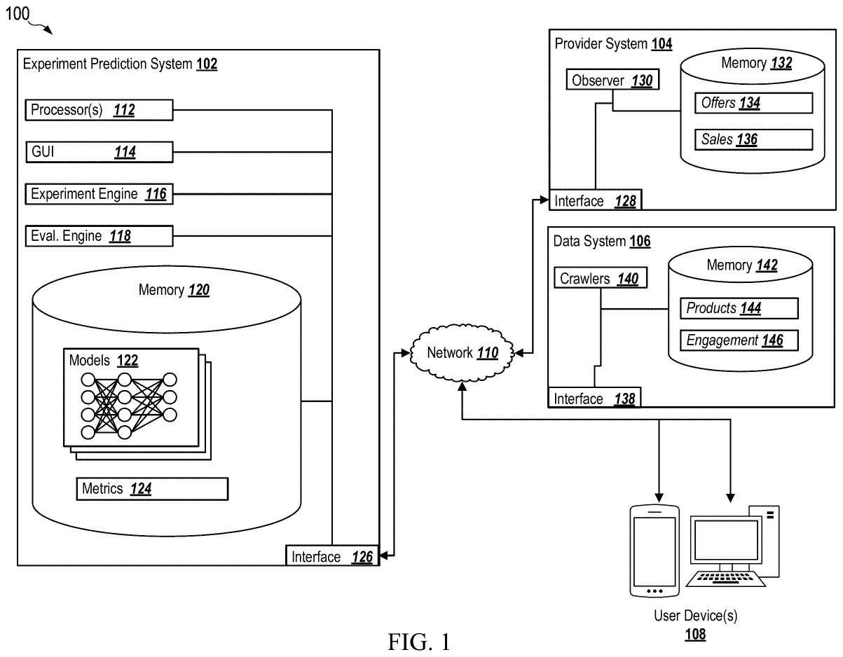

FIG. 1 illustrates a block diagram of an example system 100 for predicting experiment results in a multi-variable environment. The system 100 includes an experiment prediction system 102, a provider system 104, and a data system 106 which can be monitored by accessed or interacted with by various user devices 108. Various components within system 100 can communicate using network 110.

The experiment prediction system 102 generally identifies experiments that can be performed in a multi-variable environment (e.g., an economic market), and predicts the results of those experiments. For example, the experiment prediction system 102 can predict that lowering the price of a particular product for 2 weeks by a certain amount will result in a certain increase in demand for that product, as well as a change in revenue, and customer engagement associated with the product and the brand. The experiment prediction system 102 includes one or more processors 112, a graphical user interface (GUI) 114, an experiment engine 116, an evaluation engine 118, a memory 120 including one or more predictive models 122 and metrics 124, as well as an interface 126.

The experiment engine 116 can generate experiments to evaluate and potentially execute. For example, in a given multi-variable environment there can be a number of variables that are controllable such as price, product features, available quantity, power delivery, on/off status, speed, position, or others. The multi-variable environment can also have additional variables that are not controlled, such as customer sentiment, demand, weather, electromagnetic interference, temperature, or others. If the system is complex enough that the interrelationships between the variables is unknown or not well-defined, predicting the effects of the change of one variable in the system can be difficult. The experiment engine 116 can leverage large quantities of historical data in the form of trained predictive models 122 to produce estimated or predictive outcomes. As the models 122 become increasingly accurate, the experiment engine 116 can yield increasingly accurate results. In some implementations, the experiment engine 116 can receive a query from one or more user devices 108 (e.g., via GUI 114 discussed below), and can execute the query on one or more of the predictive models 122. For example, a query might ask what the effect on productivity for a hydroponic garden might be if the internal temperature was increased from 20° C. to 23° C. The experiment engine 116 can use predictive models 122 to predict that the yield for tomatoes in the garden might increase by 6% for the season based on the anticipated weather, and quantity of tomatoes planted. However, a decrease in yield for potatoes and increased costs of heating can be predicted to offset the increased tomato production. Therefore, an overall decrease in productivity for the garden would be predicted. In another example, a query might ask what the overall change in revenue will be if a product is offered at a 20% discount for four weeks in April. The experiment engine 116 can, for example, predict that a loss in revenue of a certain dollar amount will occur during the four week period, but also that increased demand for the remainder of the summer will cause an overall increase in revenue long-term.

The predictive models 122 can include one or more neural networks. A “neural network” can be a deep learning-based machine learning network. The neural network processes inputs and provides respective outputs, which typically include an input layer and an output layer and one or more hidden layers between the input layer and the output layer. Neural networks used in deep learning applications can often include many hidden layers, increasing the depth of the network. Each layer of the neural network can be connected in sequence such that the output of the previous layer is provided as an input to the next layer, where the input layer receives the input of the neural network, and the output of the output layer serves as the final output of the neural network. Each layer of the neural network includes one or more nodes (also referred to as processing nodes or neurons), each node processing input from the previous layer.

Generally, machine learning can include three phases, namely a training phase, a testing phase, and an application phase (also referred to as an inference phase). In the training phase, a given model may be trained by using a large amount of training data to update parameter values. In some implementations, parameter values are changed constantly and iteratively until the model obtains consistent reasoning that meets expected goals from the training data. By training, the model may be considered as being able to learn an association between input and output from training data (also referred to as mappings of input to output). In the training stage, parameter values of the trained model are determined. In the testing stage, a test input is applied to the trained model, so as to test whether the model can provide a correct output, thereby determining the performance of the model. Sometimes, the testing phase may be fused in the training phase. In the application or inference phase, the trained model may be configured to process actual model input based on the trained parameter value to determine corresponding model output.

The predictive model 122 can be deployed within the experiment prediction system 102 or may be deployed on other devices. The predictive models 122 may be based on any suitable model structure including, but not limited to, a transformer model, a convolutional neural network (CNN), a recurrent neural network (RNN), a deep neural network (DNN), or the like. In some implementations, the predictive models include XGBoost trained networks. In some implementations, the predictive models include a distributed random forest (DRF) model. In some implementations, the predictive models 122 may be based on a large language model (LLM). In some implementations, the predictive models 122 are a commercially available models or another specifically designed or trained predictive model 122. In some implementations, the models 122 are trained on offers 134, sales 136, products 144, engagement 146, metrics 124, or other resources to respond to the queries in the requested format and with predictive information query. This data can be recorded by observer 130 and/or crawlers 140 as described in more detail below. In general, the predictive models 122 can be trained to over predictions based on historical data recorded during past events or experiments.

The evaluation engine 118 can identify the performance of a predictive model as compared to new data when an experiment is performed. For example, when the four week, 20% discount experiment used above is offered, the evaluation engine 118 can retrieve revenue or sales data 136 from one or more provider systems 104, as well as engagement data 146 from a data system 106, and, using metrics 124, compare the actual results to the predicted results. In some implementations, the evaluation engine 118 can assign the experiment a performance score while it is “live” (e.g., four days into the four-week discount period). Additionally, the evaluation engine 118 can, in some instances, provide recommendations for increasing the performance of the experiment. For example, four days into the discount offer, the evaluation can determine that the demand has increased more than predicted, and, as such, the short-term revenue loss is higher than anticipated. The evaluation engine 118 can then recommend decreasing the discount from 20% to 15% in order to yield actual results closer to the predicted results.

Memory 120 represent a single memory or multiple memories. The memory 120 can include any memory or database module and can take the form of volatile or non-volatile memory including, without limitation, magnetic media, optical media, random access memory (RAM), read-only memory (ROM), removable media, or any other suitable local or remote memory component. The memory 120 can store various objects or data, including digital asset data, public keys, user and/or account information, administrative settings, password information, caches, applications, backup data, repositories storing business and/or dynamic information, and any other appropriate information associated with the experiment prediction system 102, including any parameters, variables, algorithms, instructions, rules, constraints, or references thereto. Additionally, the memory 120 can store any other appropriate data, such as metrics 124, firmware logs and policies, firewall policies, a security or access log, print or other reporting files, as well as others. While illustrated within the system 100, memory 120 or any portion thereof, including some or all of the particular illustrated components, can be located remote from the system 100 in some instances, including as a cloud application or repository or as a separate cloud application or repository when the system 100 itself is a cloud-based system.

GUI 114 of the experiment prediction system 102 interfaces with at least a portion of the system 100 for any suitable purpose, including generating a visual representation of any particular application or results and/or the content associated with any components of the user devices 108. In particular, the GUI 114 can be used to present results of a query or allow the user to input queries to the experiment prediction system 102, as well as to otherwise interact and present information associated with one or more applications. GUI 114 can also be used to view and interact with various web pages, applications, and web services located local or external to the experiment prediction system 102. Generally, the GUI 114 provides the user with an efficient and user-friendly presentation of data provided by or communicated within the system. The GUI 114 can include a plurality of customizable frames or views having interactive fields, pull-down lists, and buttons operated by the user. In general, the GUI 114 is often configurable, supports a combination of tables and graphs (bar, line, pie, status dials, etc.), and is able to build real time portals, application windows, and presentations. Therefore, the GUI 114 contemplates any suitable graphical user interface, such as a combination of a generic web browser, a web-enable application, intelligent engine, and command line interface (CLI) that processes information in the platform and efficiently presents the results to the user visually.

Each of the one or more processors 112 can be a central processing unit (CPU), an application specific integrated circuit (ASIC), a field-programmable gate array (FPGA), or another suitable component. Generally, the processor 112 executes instructions and manipulates data to perform the operations of the experiment prediction system 102. Specifically, the processor 112 executes the algorithms and operations described in the illustrated figures, as well as the various software modules and functionality, including the functionality for sending communications to and receiving transmissions from provider system 104, data system 106, as well as to other devices and systems. Each processor 112 can have a single or multiple cores, with each core available to host and execute an individual processing thread. Further, the number of, types of, and particular processors 112 used to execute the operations described herein can be dynamically determined based on a number of requests, interactions, and operations associated with the experiment prediction system 102.

Regardless of the particular implementation, “software” includes computer-readable instructions, firmware, wired and/or programmed hardware, or any combination thereof on a tangible medium (transitory or non-transitory, as appropriate) operable when executed to perform at least the processes and operations described herein. In fact, each software component can be fully or partially written or described in any appropriate computer language including Python, C, C++, JavaScript, Java™, Visual Basic, assembler, Perl®, any suitable version of 4GL, as well as others.

Interface 126 can be used by the experiment prediction system 102 to communicate with other systems in a distributed environment-including within the system 100—connected to the network 110 (e.g., provider system 104, user devices 108, and other systems communicably coupled to the illustrated experiment prediction system 102 and/or network 110. Generally, the interface 126 includes logic encoded in software and/or hardware in a suitable combination and operable to communicate with the network 110 and other components. More specifically, the interface 126 can include software supporting one or more communication protocols associated with communications such that the network 110 and/or interface's 126 hardware is operable to communicate physical signals within and outside of the illustrated system 100. Still further, the interface 126 can allow the experiment prediction system 102 to perform the operations described herein.

The provider system 104 can be a system associated with a third party or external system. For example, the provider system 104 can produce and or sell products, or otherwise manage portions of the multi-variable environment. In some implementations, the provider system 104 executes the experiment by changing one or more variables that are within their control. The provider system 104 can include an interface 128, which can be similar to or different from interface 126 as described above. Provider system 104 further includes an observer 130, which can record or log data associated with the multi-variable environment in a memory 132. For example, the observer 130 can log or record offers for sale 134, or sales data 136 over a period of time and/or with a certain periodicity. In some implementations, the observer 130 includes one or more sensors, and reads and records other parameters such as temperature, power output, and/or speed, among other suitable parameters.

The data system 106 can be a third party data service that scrapes or extracts data from various sources and provides it for reference (e.g., by experiment prediction system 102). The data system 106 can include an interface 138 and one or more memories 142, which can store information extracted from various sources. Illustrated in the example of FIG. 1, memory 142 includes products 144, which can be product information (e.g., technical details, components, features, etc.) and engagement data 146 (e.g., consumer attention, clicks, response, or sentiment information, etc.). One example of engagement data 146 can be incremental lift where the experiment is a marketing campaign, and the engagement is sales. In this example, incremental lift can be a measure of the number of sales attributable to the marketing campaign. One or more data crawlers 140 or scrapers can be used to extract data from various external locations. For example, external locations can include, but are not limited to partner data systems, websites, consumer devices, API endpoints, or other sources.

Network 110 facilitates wireless or wireline communications between the components of the system 100 (e.g., between the experiment prediction system 102, the online service 106, the user devices 108, etc.), as well as with any other local or remote computers, such as additional mobile devices, clients, servers, or other devices communicably coupled to network 110, including those not illustrated in FIG. 1. In the illustrated environment, the network 110 is depicted as a single network, but can comprise more than one network without departing from the scope of this disclosure, so long as at least a portion of the network 110 can facilitate communications between senders and recipients. In some instances, one or more of the illustrated components (e.g., the experiment prediction system 102, online service 106, provider system 104, etc.) can be included within or deployed to network 110 or a portion thereof as one or more cloud-based services or operations. The network 110 can be all or a portion of an enterprise or secured network, while in another instance, at least a portion of the network 110 can represent a connection to the Internet. In some instances, a portion of the network 110 can be a virtual private network (VPN). Further, all or a portion of the network 110 can comprise either a wireline or wireless link. Example wireless links can include 802.11a/b/g/n/ac, 802.20, WiMax, LTE, and/or any other appropriate wireless link. In other words, the network 110 encompasses any internal or external network, networks, sub-network, or combination thereof operable to facilitate communications between various computing components inside and outside the illustrated system 100. The network 110 can communicate, for example, Internet Protocol (IP) packets, Frame Relay frames, Asynchronous Transfer Mode (ATM) cells, voice, video, data, and other suitable information between network addresses. The network 110 can also include one or more local area networks (LANs), radio access networks (RANs), metropolitan area networks (MANs), wide area networks (WANs), all or a portion of the Internet, and/or any other communication system or systems at one or more locations.

User devices 108 are computing devices or computers used by one or more users and developer of the software application to interact within system 100, respectively. For example, the user devices 108 can interact with the experiment prediction system 102 to review evaluations or predictions in GUI 114. As used in the present disclosure, the term “computer” or “computing devices” is intended to encompass any suitable processing device. For example, the user devices 108 can be any computer or processing device such as, for example, a blade server, general-purpose personal computer (PC), Mac® workstation, UNIX-based workstation, or any other suitable device. In other words, the present disclosure contemplates computers other than general-purpose computers, as well as computers without conventional operating systems. Similarly, the user devices 108 can be any system that can request data and/or interact with the experiment prediction system 102. The user devices 108, in some instances, can be desktop systems, a client terminal, or any other suitable device, including a mobile device, such as a smartphone, tablet, smartwatch, or any other mobile computing device. In general, each illustrated component can be adapted to execute any suitable operating system, including Linux, UNIX, Windows, Mac OS®, Java™, Android™, Windows Phone OS, or iOS™, among others. The user devices 108 can include one or more specific applications executing on the user devices 108, or the user devices 108 can include one or more Web browsers or web applications that can interact with particular applications executing remotely from the user devices 108.

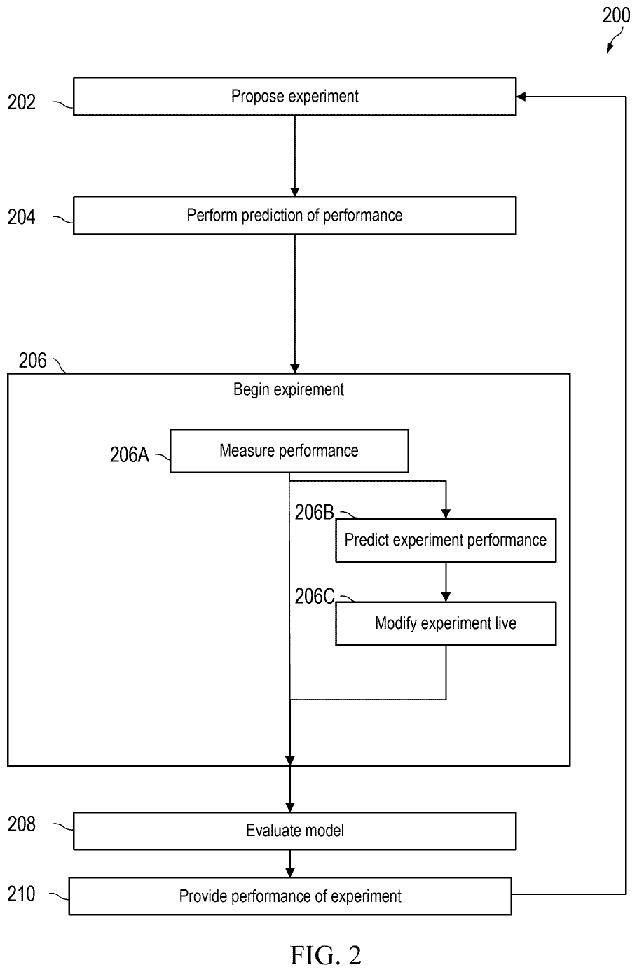

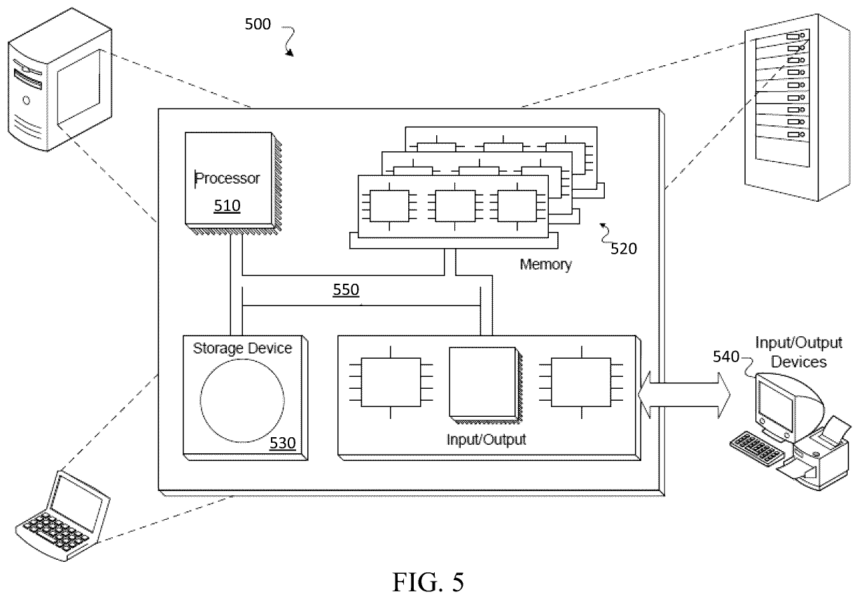

FIG. 2 is a flowchart illustrating an example process for predicting and evaluating experiment results in a multi-variable environment. The operations of process 200 can be performed, for example, based on the techniques described with respect to FIGS. 1, 3, 4, or in another manner. The operations shown in process 200 may not be exhaustive and that other operations can be performed as well before, after, or in between any of the illustrated operations. Further, some of the operations may be performed simultaneously, or in a different order than shown in FIG. 2. In some implementations, some of the operations may be performed by a computer, or multiple computers. The one or more computers the process 200 will be described as being performed by a system of, located in one or more locations, and programmed appropriately in accordance with this specification. For example, one or more of a computation system 500 of FIG. 5, appropriately programmed, can perform the process 200. As another example, one or more computer in the example system 100 (e.g., the experiment prediction system 102), when appropriately programmed, can perform the process 200.

At 202, an experiment is proposed to be conducted. For example, the experiment can be a product offer, marketing campaign, or a change in a parameter of a multi-variable environment. This proposed experiment can include changing price for a set period of time, changing a power delivery, temperature, or any other controllable variable in the multi-variable environment. In some implementations, the experiment proposal originates with a query (e.g., “what will happen to internal temperature if power is increased”). In some implementations, the experiment is proposed based on a target goal or output (e.g., “lets modify variables to identify which ones have the largest impact on temperature”). In another example, an experiment query can be: “How much will it cost to offer a 10% discount for two weeks in May? And what will be the associated incremental lift?”

At 204, the experiment is provided to a predictive model to perform a prediction on the performance of the experiment. An experiment's performance can be based on a target parameter to be changed (e.g., increase temperature, increase brand recognition, increase user engagement, decrease cost, etc.). In some implementations, the predictive model can make an estimate of what the performance of the experiment will be over different periods of time (e.g., 1 week, 1 month, 3 months, etc.). Prediction can include the collection and preparation of data, which can be filtered, pre-processed and formatted into a suitable input for a predictive model.

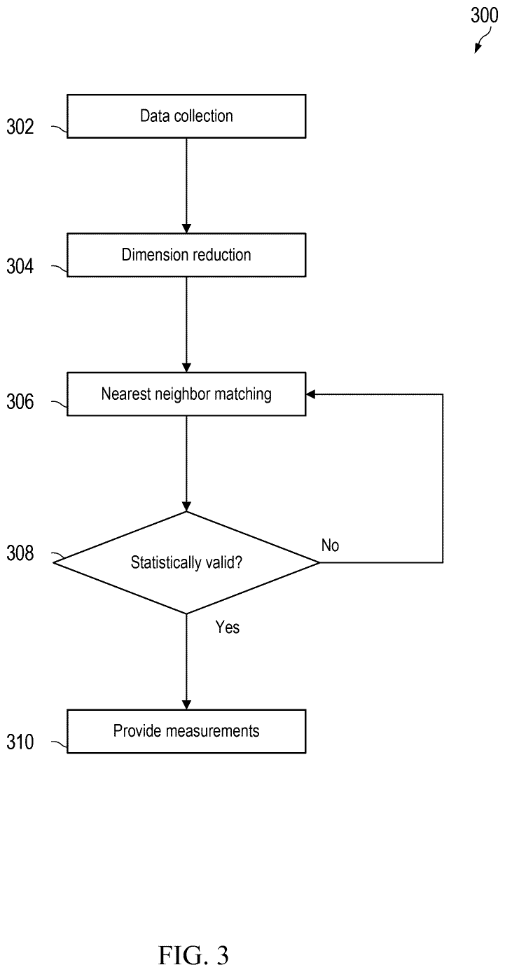

At 206, the experiment begins. This can be, for example, beginning of a discount, sale, or other promotion (e.g., advertising campaign) in an economic market. In another example, the experiment can be changing of another parameter such as the target cruise speed for merchant shipping, or others. In some implementations, the experiment is initiated and/or conducted by a third-party system (e.g., provider system 104 of FIG. 1). Once the experiment has begun, the experiment performance is measured (206A). Measuring experiment performance can be accomplished using statistical analysis, and other techniques, and is further described below with respect to FIG. 3. In some implementations, an initial predicted performance can be identified (206B) based on initially collected data. This initial performance can be, for example, and estimate of total experiment cost, sentiment uplift, etc. based on an early response (e.g., the first three days of a two week sale). Further, in some implementations, the experiment can be modified “live” or while it is in progress (206C). For example, an experiment can reduce a discount price to achieve a particular target demand or transaction rate. The transaction rate can be monitored each day of the experiment, and the discount price adjusted daily (or hourly, by the minute, or in other time intervals) in order to achieve the target transaction rate.

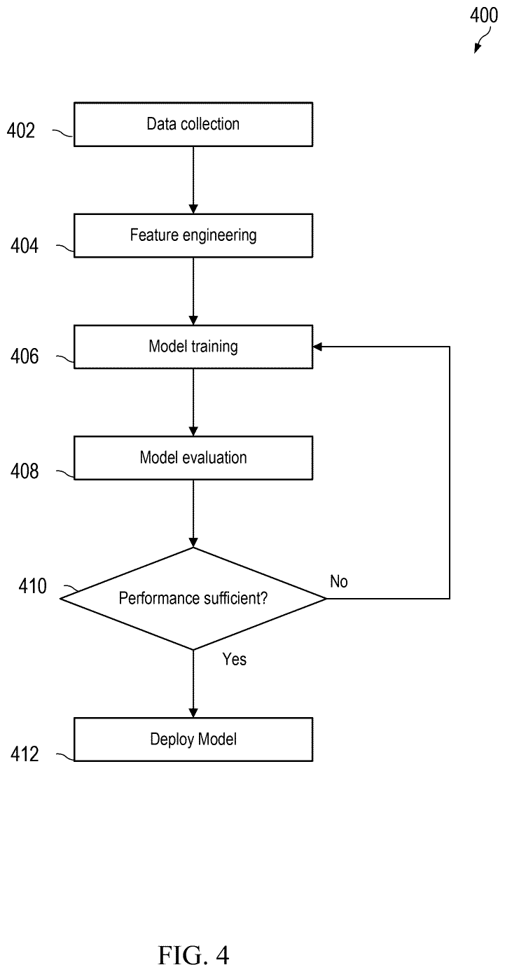

At 208, upon completion of the experiment, the predictive model is evaluated by comparing the recorded data during the experiment with the prediction. In some implementations, this evaluation includes comparing the predictive model with other models and determining which model would have performed the best. This evaluation is described in more detail below with respect to FIG. 4.

At 210, the experiment performance can be provided for analysis and review. In some implementations, the experiment performance is used to propose a new, different experiment, or improve the previous experiment. In some implementations, the experiment results are stored in a database for future training of predictive models and future analysis. In some implementations, the experiment results are anonymized or have sensitive information masked such that there is no risk of privacy leakage based on the data.

FIG. 3 is a flowchart illustrating an example process for measuring experiment performance in a multi-variable environment. The operations of process 300 can be performed, for example, based on the techniques described with respect to FIGS. 1, 2, 4, or in another manner. The operations shown in process 300 may not be exhaustive and that other operations can be performed as well before, after, or in between any of the illustrated operations. Further, some of the operations may be performed simultaneously, or in a different order than shown in FIG. 3. In some implementations, some of the operations may be performed by a computer, or multiple computers. The one or more computers the process 300 will be described as being performed by a system of, located in one or more locations, and programmed appropriately in accordance with this specification. For example, one or more of a computation system 500 of FIG. 5, appropriately programmed, can perform the process 300. As another example, one or more computer in the example system 100 (e.g., the experiment prediction system 102), when appropriately programmed, can perform the process 300.

At 302, data is collected for measurement. This data can represent controlled variables and un-controlled variables within the multi-variable environment. Additionally, the data can include other information that is related or corresponds to variables (e.g., weather data as a measure of solar irradiance, or sales amount as a measure of increased demand). Data can be collected from a variety of sources. In promotion-related intelligence solutions, those sources can include, but are not limited to, retailer loyalty systems, retailer point-of-sale systems, retail solution applications, retail data APIs, and/or retailer bulk data infrastructure files. The data can be “cleaned” or filtered to reduce noise or outliers, preprocessed (e.g., normalized, scaled, deduplicated, tokenized, etc.)

At 304, the input data undergoes a dimension reduction to format it to be suitable for the assessment. In some implementations, dimension reduction is performed using a logistic regression model. In some implementations, dimension reduction is performed by another process, such as an autoencoder network.

At 306, an algorithm is used to measure how well the experiment is performing. In some implementations, a nearest neighbor algorithm such as an approximate nearest neighbor (ANN) algorithm, or a k-nearest neighbor (KNN) algorithm is used to classify the measured data. In some implementations, the nearest neighbor algorithm is iteratively performed.

At 308, the matched data is analyzed to determine whether it is statistically valid. If a statistically valid match is created, then the match can be considered as part of the measurements, if not, additional nearest neighbor searching is required. For example, if the experiment is a product offer in an economic market, the system can consider users on whom the experiment was performed. Using, for example, an ANN and “approximate twin” who was not influenced by the product offer can be matched with each user who was influenced. In this instance, sales volume and sales frequency, as well as other metrics) can be used to generate a control group with which to evaluate the efficacy of the experiment. In some implementations, based on sales metrics prior to experiment start, matches can be evaluated as pairs. For example is “test user A” indistinguishable from “control user A” and as a pool are all test users statistically indistinguishable from all control users. In some implementations, a two-tailed test is executed to ensure that there is no statistical difference between the groups prior to the experiment.

At 310, the measured parameters can be provided as the result of a query, or for further analysis (e.g., for predicted performance 206B of FIG. 2, or model evaluation 208 of FIG. 2). These measurements can include, but are not limited to lift, trial rate, buy rate, purchase occasions or other. In some implementations, the measurements are projected to all activators including those who were not in the sample.

FIG. 4 is a flowchart illustrating an example process for evaluating the accuracy of a predictive model in a multi-variable environment. The operations of process 400 can be performed, for example, based on the techniques described with respect to FIGS. 1-3, or in another manner. The operations shown in process 400 may not be exhaustive and that other operations can be performed as well before, after, or in between any of the illustrated operations. Further, some of the operations may be performed simultaneously, or in a different order than shown in FIG. 4. In some implementations, some of the operations may be performed by a computer, or multiple computers. The one or more computers the process 400 will be described as being performed by a system of, located in one or more locations, and programmed appropriately in accordance with this specification. For example, one or more of a computation system 500 of FIG. 5, appropriately programmed, can perform the process 400. As another example, one or more computer in the example system 100 (e.g., the experiment prediction system 102), when appropriately programmed, can perform the process 400.

At 402, data is collected for measurement. This data can be controlled variables and un-controlled variables within the multi-variable environment. Additionally, the data can include other information that is related or corresponds to variables (e.g., weather data as a measure of solar irradiance). Data can be collected from a variety of sources, including but not limited to retailer loyalty systems, retailer point-of-sale systems, retail solution applications, retail data APIs, retailer bulk data infrastructure files, and/or licensed third party data files. The data can be “cleaned” or filtered to reduce noise or outliers, preprocessed (e.g., normalized, scaled, deduplicated, tokenized, etc.)

At 404, feature engineering is performed on the collected data. Feature engineering can include extracting relevant features from the raw data. For example, from eligible UPCs brand and product category can be extracted. From offer details and sales data an effective discount value can be extracted. In other words, raw data is converted into a format suitable for model training or model inputs. In another example timestamp data can be used to extract features like hour of the day or day of the week to reveal temporal trends. Effective feature engineering can enhance accuracy, reduce overfitting, reduce dimensionality, and enable the use of simpler models.

At 406, the predictive model is trained on the feature engineered dataset. In some implementations, automated training processes are used such as XGBoost, or distributed random forest (DRF) algorithms. In some implementations, multiple predictive models are trained using multiple methods, and best performing or most accurate model is selected for use. Training can be supervised or unsupervised and can include labeled or unlabeled input data. In some implementations, training is incrementally performed, with a portion of the training data reserved for analysis (e.g., the “fold”). In some implementations, multiple training and test evaluations are performed with cross-validation.

At 408, the predictive model is evaluated. In some implementation, evaluation is performed using error metrics such as mean absolute error, mean squared error, root mean squared error, or r-squared. In general, the model evaluation compares the performance of the model with the new data as compared to previous (e.g., before the most recent experiment) data. The predictive model can be evaluated against historical data, current data, or a combination thereof.

At 410, the performance based on the evaluation is determined to be either sufficient or insufficient. In some implementations, performance is sufficient when a predetermined accuracy threshold is met or exceeded. For example, if the r-squared value is greater than or equal to 89%, the model's performance can be deemed sufficient. In some implementations, other thresholds are used.

If a model's performance is insufficient, process 406 can repeat, and additional training can be performed, or a different predictive model selected.

At 412, if the model's performance is sufficient, it can be deployed. The deployed model can exist in a production environment, where, for example, a web based tool can be used to access the model and predict the performance of new experiments. In some implementations, an API can be used to seamlessly integrate predictions into internal experiment construction tools.

FIG. 5 illustrates a schematic diagram of an example computing system 500. The system 500 can be used for the operations described in association with the implementations described herein. For example, the system 500 may be included in computing devices of the one or more online components and/or the one or more offline components. The system 500 includes a processor 510, a memory 520, a storage device 530, and an input/output device 540, which are interconnected using a system bus 550. The processor 510 is capable of processing instructions for execution within the system 500. In some implementations, the processor 510 is a single-threaded processor. The processor 510 is a multi-threaded processor. The processor 510 is capable of processing instructions stored in the memory 520 or on the storage device 530 to display graphical information for a user interface on the input/output device 540.

The memory 520 stores information within the system 500. In some implementations, the memory 520 is a computer-readable medium. The memory 520 can be a volatile memory unit or a non-volatile memory unit. The storage device 530 is capable of providing mass storage for the system 500. The storage device 530 is a computer-readable medium. The storage device 530 may be a floppy disk device, a hard disk device, an optical disk device, or a tape device. The input/output device 540 provides input/output operations for the system 500. The input/output device 540 includes a keyboard and/or pointing device. The input/output device 540 includes a display unit for displaying graphical user interfaces.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random-access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship with each other. In some implementations, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

As used in this disclosure, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

As used in this disclosure, the term “about” or “approximately” can allow for a degree of variability in a value or range, for example, within 10%, within 5%, or within 1% of a stated value or of a stated limit of a range.

As used in this disclosure, the term “substantially” refers to a majority of, or mostly, as in at least about 50%, 60%, 70%, 80%, 90%, 95%, 96%, 97%, 98%, 99%, 99.5%, 99.9%, 99.99%, or at least about 99.999% or more.

Values expressed in a range format should be interpreted in a flexible manner to include not only the numerical values explicitly recited as the limits of the range, but also the individual numerical values or sub-ranges encompassed within that range as if each numerical value and sub-range is explicitly recited. For example, a range of “0.1% to about 5%” or “0.1% to 5%” should be interpreted to include about 0.1% to about 5%, as well as the individual values (for example, 1%, 2%, 3%, and 4%) and the sub-ranges (for example, 0.1% to 0.5%, 1.1% to 2.2%, 3.3% to 4.4%) within the indicated range. The statement “X to Y” has the same meaning as “about X to about Y,” unless indicated otherwise. Likewise, the statement “X, Y, or Z” has the same meaning as “about X, about Y, or about Z,” unless indicated otherwise.

Particular implementations of the subject matter have been described. Other implementations, alterations, and permutations of the described implementations are within the scope of the following claims as will be apparent to those skilled in the art. While operations are depicted in the drawings or claims in a particular order, such operations are not required to be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations are not required in all implementations, and the described components and systems can generally be integrated together or packaged into multiple products.

Accordingly, the previously described example implementations do not define or constrain the present disclosure. Other changes, substitutions, and alterations are also possible without departing from the spirit and scope of the present disclosure.

The foregoing description of the specific implementations can be readily modified and/or adapted for various applications. Therefore, such adaptations and modifications are intended to be within the meaning and range of equivalents of the disclosed implementations, based on the teaching and guidance presented herein.

The breadth and scope of the present disclosure should not be limited by any of the above-described example implementations but should be defined only in accordance with the following claims and their equivalents. Accordingly, other implementations also are within the scope of the claims.

1. A computer implemented method comprising:
identifying an experiment to perform in a multi-variable environment, wherein the experiment comprises altering one or more variables in the multi-variable environment;
providing the experiment to a predictive model to get an estimate of the experiment's effect on one or more non-altered variables of the multi-variable environment;
receiving an indication that the experiment is being performed and in response measuring a performance of the experiment as a measured performance; and
receiving an indication that the experiment is complete and in response evaluating the accuracy of the predictive model.

2. The method of claim 1, wherein the multi-variable environment is an economic market, and wherein altering the one or more variable comprises altering at least one of: price, product, advertising, or availability, and wherein the one or more non-altered variables comprise at least one of sales quantity, revenue amount, customer engagement, or incremental lift.

3. The method of claim 1, wherein the predictive model is a machine learning model trained using a gradient boosting algorithm.

4. The method of claim 1, wherein the predictive model is a distributed random forest.

5. The method of claim 1, wherein the experiment performance is measured based on a change in the one or more non-altered variables compared to a target change.

6. The method of claim 1, wherein evaluating the accuracy of the predictive model comprises comparing the estimate of the experiment's effect on the one or more non-altered variables to the measured performance.

7. The method of claim 6, wherein in response to evaluating that the accuracy of the predictive model is below a predetermined threshold, re-training the predictive model on a data set that includes the experiment.

8. The method of claim 1, comprising:
during the experiment, providing initial performance data to the predictive model to generate a predicted performance; and
modifying the experiment to enhance the predicted performance.

9. A non-transitory, computer-readable medium storing one or more instructions executable by a computer system to perform operations comprising:
identifying an experiment to perform in a multi-variable environment, wherein the experiment comprises altering one or more variables in the multi-variable environment;
providing the experiment to a predictive model to get an estimate of the experiment's effect on one or more non-altered variables of the multi-variable environment;
receiving an indication that the experiment is being performed and in response measuring a performance of the experiment as a measured performance; and
receiving an indication that the experiment is complete and in response evaluating the accuracy of the predictive model.

10. The medium of claim 9, wherein the multi-variable environment is an economic market, and wherein altering the one or more variable comprises altering at least one of: price, product, advertising, or availability, and wherein the one or more non-altered variables comprise at least one of sales quantity, revenue amount, customer engagement, or incremental lift.

11. The medium of claim 9, wherein the predictive model is a machine learning model trained using a gradient boosting algorithm.

12. The medium of claim 9, wherein the predictive model is a distributed random forest.

13. The medium of claim 9, wherein the experiment performance is measured based on a change in the one or more non-altered variables compared to a target change.

14. The medium of claim 9, wherein evaluating the accuracy of the predictive model comprises comparing the estimate of the experiment's effect on the one or more non-altered variables to the measured performance.

15. The medium of claim 14, wherein in response to evaluating that the accuracy of the predictive model is below a predetermined threshold, re-training the predictive model on a data set that includes the experiment.

16. The medium of claim 9, the operations comprising:
during the experiment, providing initial performance data to the predictive model to generate a predicted performance; and
modifying the experiment to enhance the predicted performance.

17. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
identifying an experiment to perform in a multi-variable environment, wherein the experiment comprises altering one or more variables in the multi-variable environment;
providing the experiment to a predictive model to get an estimate of the experiment's effect on one or more non-altered variables of the multi-variable environment;
receiving an indication that the experiment is being performed and in response measuring a performance of the experiment as a measured performance; and
receiving an indication that the experiment is complete and in response evaluating the accuracy of the predictive model.

18. The system of claim 17, wherein the multi-variable environment is an economic market, and wherein altering the one or more variable comprises altering at least one of: price, product, advertising, or availability, and wherein the one or more non-altered variables comprise at least one of sales quantity, revenue amount, customer engagement, or incremental lift.

19. The system of claim 17, wherein the predictive model is a machine learning model trained using a gradient boosting algorithm.

20. The system of claim 17, wherein the predictive model is a distributed random forest.
